(19) United States
(12) Patent Application Publication
(10) Pub. No.: US 2008/0071502 A1
(43) Pub. Date: Mar. 20, 2008

(54) METHOD AND SYSTEM OF RECORDING TIME OF DAY CLOCK

(75) Inventors: Mark A. Check, Hopewell Junction, NY (US); Mark S. Farrell, Pleasant Valley, NY (US); Dan F. Greiner, San Jose, CA (US); James H. Mulder, Wappingers Falls, NY (US); Damian L. Osisek, Vestal, NY (US); Robert R. Rogers, Beacon, NY (US); Timothy J. Slegel, Staatsburg, NY (US); Ronald M. Smith, Wappingers Falls, NY (US); Peter G. Sutton, LaGrangeville, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/532,172

(22) Filed: Sep. 15, 2006

(51) Int. Cl. G06F 17/40

(52) U.S. Cl. 702/186; 702/187

(57) ABSTRACT

A method is provided for obtaining time-of-day (“TOD”) clock records on an information processing system. In accordance with such method, a first instruction is issued for recording a TOD clock value. In response to issuing the first instruction, a truncated version of a first current TOD clock value is obtained and recorded as a first TOD clock record, the first TOD clock value being a first current TOD clock value produced by a TOD clock running continuously on the information processing system. Thereafter, a second instruction is issued. In response to issuing the second instruction, a truncated version of a second current TOD clock value is obtained and recorded as a second TOD clock record, the second current TOD clock value being produced by the TOD clock, and the second TOD clock record being permitted to have the same value as the first TOD clock record.

### BACKGROUND OF THE INVENTION

The present invention relates to information processing systems, and more specifically to an information processing system and corresponding method for recording time-of-day clock data.

As used herein, the term “information processing system” denotes general or special purpose digital computing equipment which includes one or a plurality of processors, each capable of executing one or more programs to digitally process a set of information input to such processor in digital form. Certain programs when executed on an information processing system record time-of-day (“TOD”) clock data as timestamps or “time-of-day (TOD) clock records.” In conventional systems, each TOD clock record is required to record a unique point in time (the combination of time of day and date) and must advance monotonically in relation to all prior TOD clock records. Stated another way, a TOD clock record must indicate a TOD clock value that is later in time than the time indicated by the immediately preceding TOD clock record. Such TOD clock records can be used to add a measure of security to certain applications such as used to record financial transactions. By requiring each later obtained TOD clock record to show a later time than the immediately preceding TOD clock record, the information processing system safeguards against the same operation being performed simultaneously several times with respect to the same repository of data. For example, TOD clock records are commonly used to prevent financial transactions from being executed simultaneously multiple times against the same funds.

In S/370 computing architecture, first released during the 1970s, an executable instruction having the instruction name of “STORE CLOCK” or “STCK” can be used to record a TOD clock record in a 64 bit (eight byte) field. Each processing element of the information processing system which is capable of executing the broadest range of general purpose instructions of the instruction set is referred to as a “processor”, this term having supplanted the term “central processing unit” (CPU). In early S/370 systems and compatible systems, the rightmost (highest precision) bits of the 64 bit field can be used as a processor identifier to identify a processor of the information processing system that executed the instruction. In such case, using the rightmost bits of the field to record the processor identifier would decrease the precision of the TOD clock record that was also recorded in the 64 bit wide field.

The earliest information processing systems to implement S/370 architecture had only a few processors per information processing system. Thus, two bits of the 64 bit field were sufficient to identify one processor of an information processing system having four processors, and three bits were sufficient to identify one of eight processors of the information processing system. The earliest information processing systems to implement S/370 architecture also had machine cycles with much longer durations than now. A machine cycle is commonly known as a minimum time interval for executing a simple instruction on the information processing system. Given the duration of the machine cycle in those earlier systems and the relatively small number of processors they included, the 64 bit width field of the TOD clock record was more than adequate to assure that the value of the TOD clock record would advance each time it was recorded.

Since the initial release of S/370 architecture, advances have increased the speed of executing instructions on information processing systems, such that the machine cycle is significantly smaller than when it was first released. In addition, today information processing systems which are capable of executing instructions from the instruction set of the S/370 architecture typically have a much greater number of processors than the earliest S/370 compatible systems. Information processing systems today can have up to 64 processors and future processing systems will likely have 100 or more processors.

Because of this, typically a greater number of the rightmost (highest precision) bits of the 64 bit field of the TOD clock record are needed to store a processor identifier. Given their much shorter machine cycles, it is almost inevitable that the processors of today's systems seek to store TOD clock records at a faster rate than the rate of change of relatively imprecise TOD clock records having 64 bit fields.

Prior to the present invention, one way of satisfying the requirement that the TOD clock record advance monotonically each time it was recorded was to delay completion of the STORE CLOCK instruction until the TOD clock record would advance as required.

However, such delay degraded the performance of applications which required TOD clock records to be stored frequently. A flowchart illustrating the use of the STORE CLOCK or (“STCK”) instruction is provided in FIG. 1. As shown therein, a STCK instruction is issued (block 10), after which a first TOD clock record is obtained from the TOD clock and recorded (block 20). Thereafter, the STCK instruction is issued again (block 30). In block 40, a determination is made whether a TOD clock value to be recorded in response to the later issued STCK instruction has increased. If the value of the TOD clock that is recordable by the number of bits of the TOD clock record allotted thereto has increased, then a second TOD clock record is recorded (block 60). However, as described above, sometimes when the value of the TOD clock is checked soon again after being recorded the first time, the TOD clock value does not increase. In such case, the TOD clock value is not yet recordable. Instead, the processor on which the TOD clock instruction is issued the later time must wait, e.g., perform one or more NO-OP instructions in succession, or otherwise use up machine cycles until recording the TOD clock record the later time. As is apparent, the processor operates less efficiently when machine cycles are used to perform NO-OP instructions or to do wasteful operations while waiting for the recordable value of a TOD clock to increase.

Another way of assuring that the TOD clock record would advance each time is to provide a field having a greater number of bits, and hence greater precision than 64, for storing the TOD clock record and processor identifier. The STORE CLOCK EXTENDED instruction, which was introduced in one release of the ESA/390 architecture stores a TOD clock record and processor identifier in a 104 bit wide field to retain much greater precision than the original 64 bit wide field.

However, because of the greater width of the data field returned by the STORE CLOCK EXTENDED instruction, the use of such instruction can require previously coded applications to be recoded and retested. The prior art failed to address performance problems of applications which issue frequent STORE CLOCK instructions for storing time-of-day clock records.

### SUMMARY OF THE INVENTION

In accordance with a first aspect of the invention, a method is provided for obtaining time-of-day (“TOD”) clock records on an information processing system. In accordance with such method, a first instruction is issued for recording a TOD clock value. In response to issuing the first instruction, a truncated version of a first current TOD clock value is obtained and recorded as a first TOD clock record, the first TOD clock value being a first current TOD clock value produced by a TOD clock running continuously on the information processing system. Thereafter, a second instruction is issued. In response to issuing the second instruction, a truncated version of a second current TOD clock value is obtained and recorded as a second TOD clock record, the second current TOD clock value being produced by the TOD clock, and the second TOD clock record being permitted to have the same value as the first TOD clock record.

### BRIEF DESCRIPTION OF THE DRAWINGS

FIG. 1 is a flowchart illustrating a method of obtaining and recording TOD clock records in accordance with the prior art;

FIG. 2 is a block diagram illustrating an exemplary computing environment which supports use of the method and system in accordance with the embodiments of the invention;

FIG. 3 is a diagram illustrating an organization of bits representing a recorded TOD clock value and processor identifier (“PID”) in accordance with an embodiment of the invention;

FIG. 4 is a flowchart illustrating a method of recording TOD clock values using a STORE CLOCK FAST instruction, in accordance with one embodiment of the invention; and

FIG. 5 is a flowchart illustrating a method of recording TOD clock values using a TRACE instruction, in accordance with another embodiment of the invention.

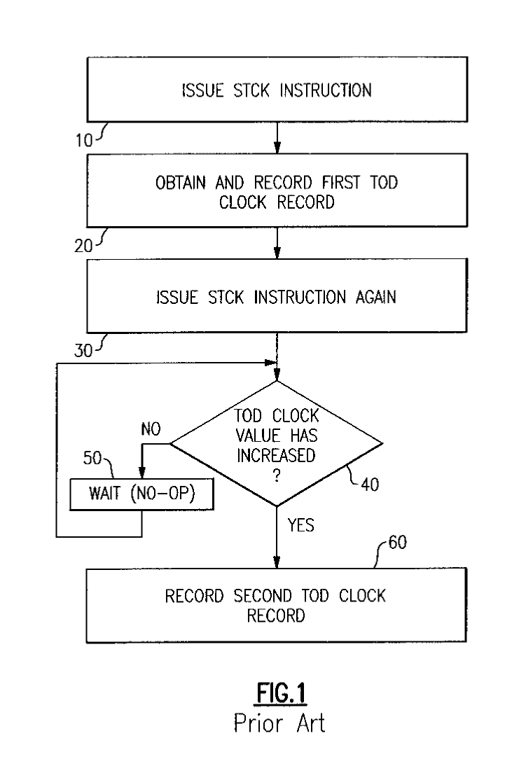

### DETAILED DESCRIPTION

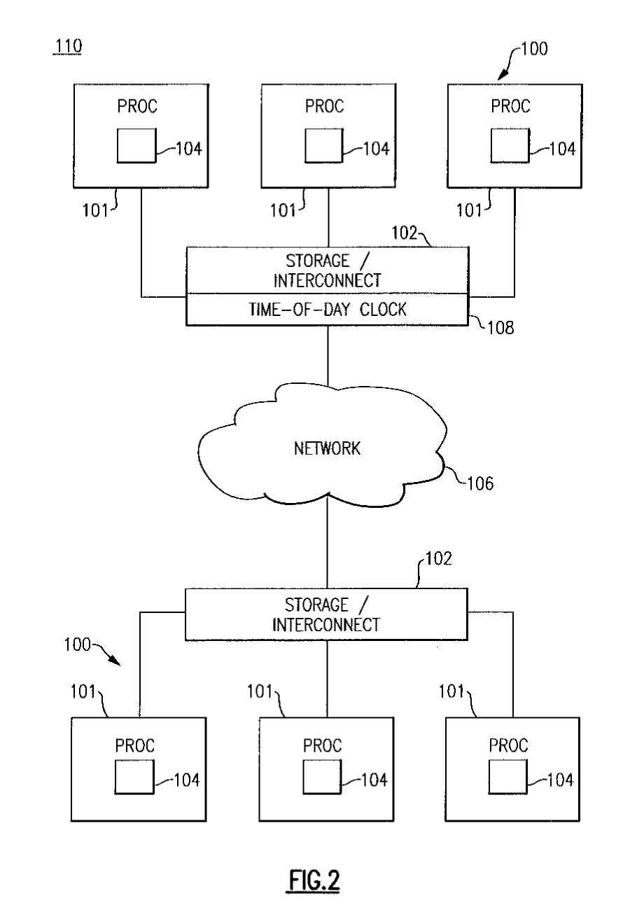

FIG. 2 illustrates a computing environment 110 which supports the performance of a method in accordance with an embodiment of the invention. In the computing environment illustrated in FIG. 2, a multi-processor system 100 includes a plurality of physical processors 101 linked together via a common storage and interconnect subsystem 102, as shown in the upper half of FIG. 2. The term “physical processor” denotes the hardware together with microcode, firmware and lowest level processing software for enabling the physical processor to support the operation of an operating system and processes subject to its control. While the multi-processor system is illustrated with only three physical processors, it is possible for the multi-processor system to have fewer or a greater number of physical processors. The storage and interconnect subsystem 102 contains certain storage and communication resources which are subject to being shared among the physical processors. Typically, each physical processor also possesses processor-specific resources such as processor storage 104 or communication resources that are possessed exclusively by the physical processor. Sometimes, only certain reconfigurable portions of the processor storage 104 are possessed exclusively by a particular physical processor, while other reconfigurable portions are designated for the exclusive use of another one of the physical processors. The allocation of such processor storage 104 and portions of common storage within the storage and interconnect subsystem 102 is performed for a variety of goals such as performance, reliability and security. As seen in FIG. 2, the computing environment includes a time-of-day (“TOD”) clock 108. The TOD clock 108, which runs continuously, is readable at the request of one of the processors 104 of the multiprocessor system to provide a TOD clock value. The degree of precision achieved by the TOD clock can be relatively high, even as high as possible given the number of bits of precision used to indicate the current value by the TOD clock. However, as described below, the degree of precision of TOD clock values as recorded in response to requests by the processors is limited by the architecture used for recording TOD clock values.

As further shown in FIG. 2, the computing environment 110 includes a second multi-processor system 100, illustrated in the lower half of FIG. 2, the second multi-processor system 100 including physical processors 101 and a storage and interconnect subsystem 102 which, desirably are similar to those of the above-described multi-processor system, but which need not be the same. Each physical processor contains the computing resources, e.g., state machines and other hardware and microprograms which assist in operating the hardware to execute instructions. Each physical processor may further include a set of extended microprograms which may include “millicode” or firmware which also assists in operating the hardware when executing an instruction.

A network 106, e.g., one which can operate with a high data transmission rate or which might not, supports the transmission of data between the two multi-processor systems 100, as well as control messages which facilitate or manage such data transmission. In one example, the two multi-processor systems can operate as loosely-coupled systems, each of which executes an independent process, but in which data and/or instructions, such as, for example, “applets” are distributed ad hoc or occasionally between the two multi-processor systems. In another example, the two multi-processor systems can operate as tightly-coupled systems in which data and/or instructions are exchanged frequently, such as for parallel processing of a task having a large computing volume. As seen in FIG. 2, a single TOD clock 108 can be used to maintain a common TOD clock reference for the whole computing environment 110 including both of the multiprocessor systems 100 shown in FIG. 2.

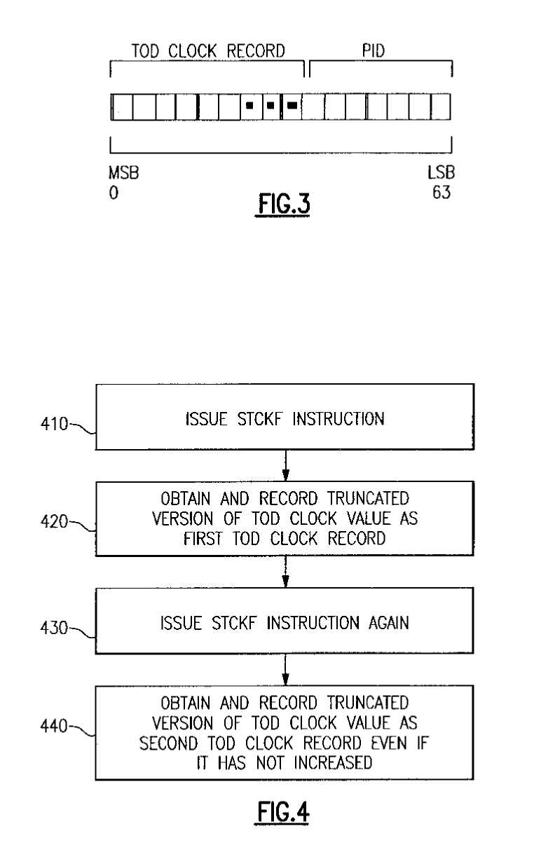

FIG. 3 illustrates a data format of a TOD clock record which is recordable through use of a STORE CLOCK FAST (“STCKF”) instruction in accordance with a method according to one embodiment of the present invention. As illustrated therein, a TOD clock record is recorded as a truncated series of bits within a field having a limited number of total bits, e.g., 64 bits. In such embodiment, as recorded in the 64 bit field, the rightmost (highest precision bits) of the TOD clock value are lost, due to a requirement to record a processor identifier (“PID”). In a computing environment 11 which has a large number of processors, e.g., 100 or more, the minimum number of bits required to uniquely identify each of 100 processors is seven. As illustrated in FIG. 3, the seven rightmost bits of the 64 bit field are reserved for recording the PID, and only the remaining bits to the left of those seven bits are used to record the TOD clock record. As is apparent, the reduced number of bits of the 64 bit field which are available for recording the TOD clock record reduce the precision at which the TOD clock record is entered.

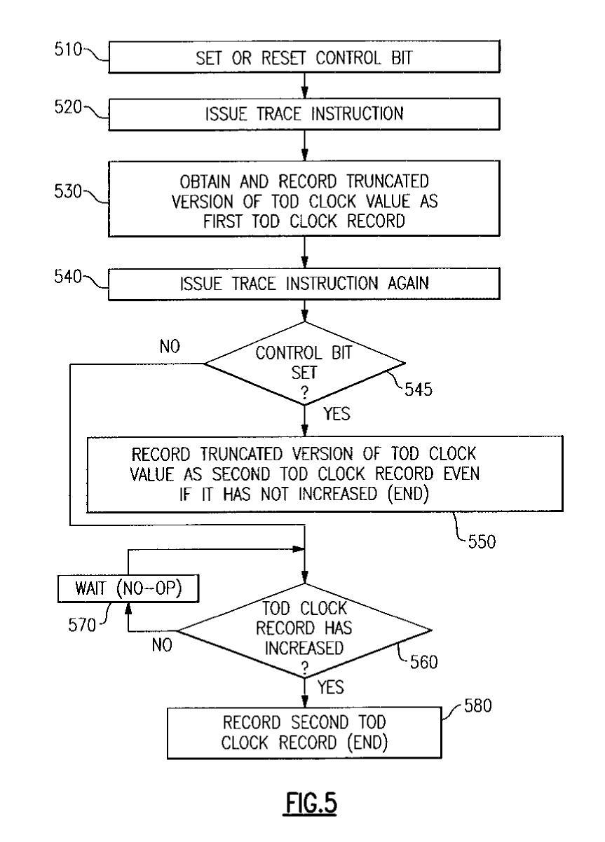

In accordance with an embodiment of the invention, a method of obtaining and recording TOD clock records will now be described with reference to the flowchart of FIG. 4. As illustrated in FIG. 4, an instruction having an instruction name of “STORE CLOCK FAST” or “STCK” is issued in block 410. In response to issuing that instruction, a right truncated version of a TOD clock value maintained by the TOD clock 108 is obtained and recorded as a first TOD clock record (block 420). Thereafter, as indicated in block 430, at some later point in time the STCKF instruction is issued again by the same or another processor of the multiprocessor system. In response to issuing the STCKF instruction again, a right truncated version of a TOD clock value maintained by the TOD clock is obtained and recorded (block 440), this being referred to as a second TOD clock record. Unlike the method described above as background to the present invention, in the method according to the present invention, the second TOD clock record is recorded even if very little time elapses between the times that the first and second TOD clock records are initially recorded. The second TOD clock value, in the number of bits which are recordable on the information processing system, need not have changed since the TOD clock value was recorded last, and can even be exactly the same as one or more previously obtained TOD clock records. The STCKF instruction allows the truncated second TOD clock record to be recorded even if it would show a value which is unchanged from the last time that the TOD clock record was entered.

In a variation of the embodiment of the invention, the data format of the TOD clock record obtained by executing the STORE CLOCK FAST instruction is different than that illustrated above in FIG. 3. In this case, each record of the TOD clock need not include a PID identifying the processor which requested the TOD clock to be recorded, since the result of the STORE CLOCK FAST instruction is not required to be unique. Without the PID, the rightmost bits within the 64 bit record are available to record more precise bits of the TOD clock, and higher precision TOD clock records can be obtained through executing the STORE CLOCK FAST instruction.

Another embodiment of the invention will now be described with reference to FIG. 5. In this embodiment, a TOD clock record is stored in response to issuing an instruction having an instruction name of “TRACE.” The TRACE instruction is reconfigurable by the setting of a “control bit”, i.e., a particular bit in a control register. The control bit is preferably is one that is unused in systems in accordance with a previously released compatible architecture, such that the control bit is only effective when it is set to a state that did not occur in accordance with such previously released architecture. Therefore, when the control bit has a state of “zero” the control bit does not affect operation and the TRACE instruction records the TOD clock value in a manner similar to the result of executing the prior art STCK instruction. In such case, the TOD clock value is only recorded when its recordable value has changed in relation to the immediately preceding TOD clock record that was obtained. However, when the control bit is set to “one”, the TRACE instruction records the TOD clock value in the manner described above for the STCKF instruction. The TOD clock value is recorded in response to issuing the TRACE instruction, regardless of whether the value of the TOD clock that is recordable by the TRACE instruction has changed since the most recent time that the TRACE instruction has been issued.

Referring to FIG. 5, in accordance with a particular embodiment of the invention, a method is provided for using an instruction having the instruction name of “TRACE” to obtain and record TOD clock records. In block 510, a control bit of a control register is set for controlling whether the TOD clock values recorded by the TRACE instruction are required to monotonically increase each time a record of the TOD clock value is made. After setting the control bit, the TRACE instruction is issued, as shown in block 520. In response to issuing that instruction, a right truncated version of a TOD clock value maintained by the TOD clock 108 (FIG. 2) is obtained and recorded as a first TOD clock record (block 530). Thereafter, as indicated in block 540, at some later point in time the TRACE instruction is issued again by the same or another processor of the multiprocessor system.

The method of recording the TOD clock value from one time to the next in response to the TRACE instruction varies according to the setting of the bit therefor in the control register. Therefore, as shown in block 545, the setting of the control bit is determined. If the control bit is set to “one”, then the TRACE instruction records a truncated version of the current value of the TOD clock as a second TOD clock record (block 550). A truncated version of the current TOD clock value is then obtained and recorded (550) as a second TOD clock record even if the recordable (truncated) value of the TOD clock value has not changed since the last time that the TOD clock value was recorded.

However, when at block 540 it is determined that the control bit is not set, i.e., remains at “zero,” issuance of the TRACE instruction produces a different result. In this case, operation proceeds in accordance with steps 560, 570 and 580. In block 560, a determination is made whether a TOD clock value to be recorded in response to the later issued TRACE instruction has increased. If the value of the TOD clock that is recordable by the number of bits of the TOD clock record allotted thereto has increased, then a second TOD clock record is recorded (block 580).

However, sometimes when the value of the TOD clock is checked soon again after being recorded the first time, the TOD clock value does not increase. In that case, when the value of the control bit is “zero,” the TOD clock value is not yet recordable. Instead, the processor on which the TOD clock instruction is issued the later time must wait, e.g., perform one or more NO-OP instructions in succession (block 570), or otherwise use up machine cycles before it records the TOD clock at the later time. Once enough machine cycles of a processor 104 of the multiprocessor system 100 (FIG. 2) have elapsed for the recordable bits of the TOD clock value to show an increased value over the last recorded TOD clock value, the result at block 560 becomes YES. Then, the second TOD clock value is recorded, as indicated in block 580, the second TOD clock record showing a TOD clock value which has increased in relation to the earlier recorded TOD clock value.

While the invention has been described in accordance with certain preferred embodiments thereof, many modifications and enhancements can be made thereto without departing from the true scope and spirit of the invention, which is limited only by the claims appended below.

What is claimed is:

1. A method of obtaining time-of-day (“TOD”) clock records on an information processing system, comprising:
issuing a first instruction for recording a TOD clock value;
in response to issuing the first instruction, obtaining and recording a truncated version of a first current TOD clock value as a first TOD clock record, the first current TOD clock value produced by a TOD clock running continuously on the information processing system;
thereafter issuing a second instruction; and
in response to issuing the second instruction,
obtaining and recording a truncated version of a second current TOD clock value as a second TOD clock record, the second current TOD clock value being produced by the TOD clock and the second TOD clock record being permitted to have the same value as the first TOD clock record.

2. The method as claimed in claim 1, wherein each of the first instruction and the second instruction has the same instruction name.

3. The method as claimed in claim 2, wherein each of the first instruction and the second instruction has an instruction name: STORE CLOCK FAST.

4. The method as claimed in claim 2, wherein the each of the first instruction and the second instruction has an instruction name: TRACE.

5. The method as claimed in claim 1, wherein the first instruction and the second instruction have different names.

6. The method as claimed in claim 5, wherein one of the first and second instructions has an instruction name of STORE CLOCK FAST and the other of the first and second instructions includes an instruction name of TRACE.

7. The method as claimed in claim 1, wherein the information processing system includes a plurality of processors including first and second processors, the first instruction being issued by the first processor and the second instruction being issued by the second processor.

8. The method as claimed in claim 1, wherein the information processing system includes a plurality of processors and the first and second instructions are issued by a single one of the plurality of processors.

9. The method as claimed in claim 1, wherein the data length of each one of the first TOD clock record and the second TOD clock record is sixty-four bits.

10. The method as claimed in claim 7, wherein the first TOD clock record is recorded in a single field having a fixed data length, the method further comprising recording a first processor identifier (“PID”) with the first TOD clock record in the field, the first PID identifying the first processor, wherein the degree of truncation of the first current TOD clock value varies in accordance with the data length of the recorded first PID.

11. The method as claimed in claim 10, wherein the data length of the recorded first PID varies in accordance with a number of unique PIDs provided to the plurality of processors of the information processing system.

12. A computer-readable recording medium having information recorded thereon, the information being readable by the information processing system to configure the information processing system to perform a method of obtaining time-of-day (“TOD”) clock records on the information processing system, the method comprising:
issuing a first instruction for recording a TOD clock value;
in response to issuing the first instruction, obtaining and recording a truncated version of a first current TOD clock value as a first TOD clock record, the first current TOD clock value produced by a TOD clock running continuously on the information processing system;
in response to issuing the second instruction,
obtaining and recording a truncated version of a second current TOD clock value as a second TOD clock record, the second current TOD clock value being produced by the TOD clock and the second TOD clock record being permitted to have the same value as the first TOD clock record.

13. The recording medium as claimed in claim 12, wherein each of the first instruction and the second instruction has the same instruction name.

14. The recording medium as claimed in claim 13, wherein each of the first instruction and the second instruction has the instruction name: STORE CLOCK FAST.

15. The recording medium as claimed in claim 13, wherein each of the first instruction and the second instruction has the instruction name: TRACE.

16. The recording medium as claimed in claim 12, wherein the first instruction and the second instruction have different instruction names.

17. The recording medium as claimed in claim 16, wherein one of the first and second instructions has the instruction name: STORE CLOCK FAST and the other of the first and second instructions has the instruction name: TRACE.

18. An information processing system comprising:
a TOD clock operable to run continuously;
one or more instruction issue units operable to issue a first instruction and thereafter a second instruction for recording time-of-day (“TOD”) clock records, each TOD clock record representing a TOD clock value that is produced by a TOD clock operable to run continuously; and
one or more execution units operable to obtain and record a truncated version of a first current TOD clock value from the TOD clock as a first TOD clock record in response to issuing the first instruction, and to obtain and record a truncated version of a second current TOD clock value from the TOD clock as a second TOD clock record in response to issuing the second instruction, wherein the second TOD clock record is permitted to have the same value as the first TOD clock record.

19. The information processing system as claimed in claim 18, wherein each of the first instruction and the second instruction has an instruction name: STORE CLOCK FAST.

20. The information processing system as claimed in claim 18, wherein each of the first instruction and the second instruction has an instruction name: TRACE.
